(19) United States
(12) Patent Application Publication
(10) Pub. No.: US 2024/0239937 A1
(43) Pub. Date: Jul. 18, 2024

(54) CATIONIC POLYVINYL ALCOHOLS

(71) Applicant: The Procter & Gamble Company, Cincinnati, OH (US)

(72) Inventor: Jana Verena Margarethe HERZBERGER, Florence, KY (US)

(21) Appl. No.: 18/410,172

(22) Filed: Jan. 11, 2024

Related U.S. Application Data
(60) Provisional application No. 63/438,800, filed on Jan. 13, 2023.

(51) Int. Cl. C08F 261/04; C08F 8/28

(52) U.S. Cl. CPC C08F 261/04; C08F 8/28; C08F 2810/30

(57) ABSTRACT

A liquid hand dishwashing detergent composition containing a cationically modified polyvinyl alcohol, methods of making the liquid hand dishwashing detergent compositions, and methods of using said liquid hand dishwashing detergent compositions, which provide improved rinsing, solution feel, and finished product viscosity control.

### FIELD OF THE INVENTION

The invention relates to cationically modified polyvinyl alcohols and their use in compositions including solutions/dispersions, sheets and films and as coatings.

### BACKGROUND OF THE INVENTION

Cationically modified polymers are useful in a range of compositions including consumer goods compositions such as surface cleaning/treatment compositions, personal care compositions, and the like, and as components useful in constructing compositions such as films and coatings.

For example, cationically modified polymers, including cationically modified water-soluble polymers are useful in surface cleaning compositions such as dish cleaning compositions. Hard surface cleaning and dishwashing, both manual and automatic, are time-consuming tasks and there is an increasing desire to spend less time and effort washing dishware. Often, such tasks rely on anionic or amphoteric surfactants to clean the hard surface. However, a drawback to such surfactants is that it can be difficult to rinse away the resultant suds. As such, long rinse times are often required to remove all the suds from the hard surface being cleaned. In addition, the rinse solution can feel slippery or oily, which can give the user the impression that the hard surfaces that have been treated are insufficiently cleaned. Moreover, it can take a while for the surfaces to dry. While the surfaces are wet, they remain slippery, which is dangerous for floors and the like, and for articles such as dishware, means that the articles cannot be stored away until dry.

Cationically modified hydroxyethyl cellulose has also been found to provide efficient foam rinsing. For instance, JP6640055B2, JP2019172819A, JP2018035251A, JP2018035252A and JP2020152757A all describe liquid detergent composition for dishes which comprise cationized cellulose and have improved detergency, foaming properties and drainability. However, cationically modified hydroxyethyl cellulose also has several drawbacks, including an increase in finished product viscosity and poor solution feel, for example, giving the wash solution a slippery or oily feel. Various other polymers have been used to improve sudsing, such as the hydroxypropylcellulose polymers described in EP4089159A, or as viscosity modifiers, such as the hydroxyethylcellulose polymers described in GB2427614A. Polyvinyl alcohols, such as those described in EP3730594A1 have been found to provide improved suds longevity, though this is at the expense of rinsability. Copolymers of polyvinyl alcohol, such as those described in EP application EP22180286.1 have also been found to further improve suds longevity.

Polyvinyl alcohols can be particularly desirable, particularly when formulating compositions that require at least partial water solubility. At least partial water-solubility of the polymer can be advantageous, for example, when formulating aqueous compositions or when formulating water-soluble films or when formulating coatings (i.e. such as coating for particles) that are applied via aqueous compositions or deposited from aqueous compositions (i.e. coacervates).

A small number of cationically modified polyvinyl alcohols are currently known. Wang and Ye (Polym. Int. 2012; 61 pp 571-580) describe the structure and properties of cationic polyvinyl alcohol. Ma et al. (J. Appl. Polym. Sci. 2016, 133, 43888) described the functional modification of polyvinyl alcohol by copolymerizing with a cationic double alkyl-substituted monomer.

Yet, both these classes of cationically modified polyvinyl alcohols suffer from the disadvantage of increased hydrophilicity (introducing additional heteroatoms to the polymer) that is introduced in addition to the cationic moiety, which limits the flexibility of polymer properties.

### SUMMARY OF THE INVENTION

Cationically modified polyvinyl alcohols are provided that have the formula (I):

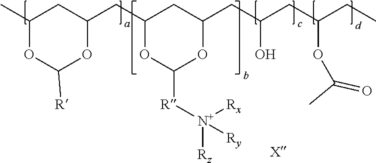

In the formula, a, b, c, and d may be expressed as non-integer values. When a, b, c, and d, are expressed as non-integer values these values represent the average value of a, b, c, and d, over range of values for individual molecules in a given sample.

The materials of the present invention include materials according to formula (I) wherein:
a is from 0 to 5.0;
b is from 0.1 to 20;
c is from 40 to 98, preferably from 65 to 95, preferably from 70 to 88, more preferably from 75 to 85; and
d is from 1.0 to 25, preferably from 3.0 to 20, preferably from 8.0 to 15; and

R′ (when a>0) represents C1 to C18 alkyl, preferably C3 to C15 alkyl, preferably C5 to C12 alkyl. The C₁ to C₁₈ alkyl R′ group can be linear or branched, substituted or unsubstituted. R′ may be selected from phenyl, alkyl phenyl, phenyl alkyl or a derivative thereof.

R″ is a disubstituted hydrocarbon moiety that has from 2.0 to 5.0 carbons, preferably from 2.0 to 4.0, more preferably 3.0 carbons, that is, R″ is more preferably a linear —CH₂—CH₂—CH₂-moiety.

a is the mol % of hydrophobic monomers, b is the mol % of substituted ammonium monomers, c the mol % of vinyl alcohol monomers and d is the mol % of vinyl acetal monomers. a+b+c+d add up to at least 90, preferably 98 and more preferably 100, excluding residues such as initiation molecules and the like. The hydrophobic monomer can be linear, branched or aromatic. The monomers may be present as blocks or randomly distributed, or a mix of blocks units and randomly distributed

### BRIEF DESCRIPTION OF THE DRAWINGS

While the specification concludes with claims particularly pointing out and distinctly claiming the subject matter that is regarded as the present disclosure, it is believed that the disclosure will be more fully understood from the following description taken in conjunction with the accompanying drawings. Some of the FIGURES may have been simplified by the omission of selected elements for the purpose of more clearly showing other elements. Such omissions of elements in some FIGURES are not necessarily indicative of the presence or absence of particular elements in any of the exemplary embodiments, except as may be explicitly delineated in the corresponding written description. None of the drawings are necessarily to scale.

FIG. 1 shows the reaction scheme for the quaternization of 4-(dimethylamino)butyraldehyde diethyl acetal (cationic acetal).

### DETAILED DESCRIPTION OF THE INVENTION

It has been found that the cationically modified polyvinyl alcohols where the modification includes an acetal linkage between the cationic moiety and the polyvinyl alcohol backbone of the polymer (as described herein) provide the benefits of cationically modified polyvinyl alcohols and cationic polymers more generally. These novel materials, while being highly functional as cationic polymers, are relatively easy to synthesize and provide for a wide variety of substituent modification to allow not only the cationic modification but any of a number of other modifications including hydrophobic modification.

Cationic polyvinyl alcohol polymers of the present invention are also useful in applications where the charge can impart unique properties and benefits, such as aiding water solubility, improving dissolution rates, and/or adsorbing or depositing on to interfaces. Such cationic polyvinyl alcohol polymers may be used in solid or semi-solid forms, including coatings, films, fibers, and discrete shapes. Alternatively, they may be dissolved and formulated in a composition for example to treat a surface, promote adhesion between two surfaces, act as an emulsifier for oils, a dispersant for particles, and/or as a deposition aid for active ingredients.

For example, it has been found that cationically modified polyvinyl alcohols as described herein, provide cleaning and treatment compositions having good foaming during use, while also being easier to rinse, shorter drying times, and improved rinse feel.

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present invention can comprise, consist of, and consist essentially of the essential elements and limitations of the invention described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease in the material) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

As used herein, the term “polysaccharide” means a polymeric carbohydrate molecule composed of long chains of monosaccharide units bound together by glycosidic linkages and on hydrolysis gives the constituent monosaccharides or oligosaccharides.

A “cationic derivative of a polysaccharide” is understood to be a polysaccharide or a derivate of a polysaccharide comprising a cationic group. The cationic group may comprise an ammonium group, a quaternary ammonium group, a sulfonium group, a phosphonium group, a transitional metal or any other positively charged functional group. A preferred cationic group is a quaternary ammonium group.

The term “sudsing profile” as used herein refers to the properties of the composition relating to suds character during the dishwashing process. The term “sudsing profile” of the composition includes initial suds volume generated upon dissolving and agitation, typically manual agitation, of the composition in the aqueous washing solution, and the retention of the suds during the dishwashing process. Preferably, hand dishwashing compositions characterized as having “good sudsing profile” tend to have high initial suds volume and/or sustained suds volume, particularly during a substantial portion of or for the entire manual dishwashing process. This is important as the consumer uses high suds as an indicator that enough composition has been dosed. Moreover, the consumer also uses the sustained suds volume as an indicator that enough active cleaning ingredients (e.g., surfactants) are present, even towards the end of the dishwashing process. The consumer usually renews the washing solution when the sudsing subsides. Thus, a low sudsing composition will tend to be replaced by the consumer more frequently than is necessary because of the low sudsing level.

“Easy rinsing” or “an easy rinsing profile” means that the foam generated during the main wash cycle can be rinsed faster and less water can be used to collapse the foam from the main wash cycle. Faster collapsing of the foam is preferred to reduce the amount of time spent rinsing and overall washing time, as well. Reducing the amount of water used to collapse the foam is preferred because it aids in water conservation.

It is understood that the test methods that are disclosed in the Test Methods Section of the present application must be used to determine the respective values of the parameters of Applicants' inventions as described and claimed herein.

All percentages are by weight of the total composition, as evident by the context, unless specifically stated otherwise. All ratios are weight ratios, unless specifically stated otherwise, and all measurements are made at 25° C., unless otherwise designated.

### Cationic Polyvinyl Alcohol

The cationically modified polyvinyl alcohol of the present invention has the formula (I):

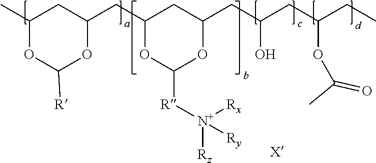

In the formula, a, b, c, and d may be expressed as non-integer values. When a, b, c, and d, are expressed as non-integer values these values represent the average value of a, b, c, and d, over range of values for individual molecules in a given sample.

The materials of the present invention include materials according to formula (I) wherein:
a is from 0 to 5.0;
b is from 0.1 to 20;
c is from 40 to 98, preferably from 65 to 95, preferably from 70 to 88, more preferably from 75 to 85; and
d is from 1.0 to 25, preferably from 3.0 to 20, preferably from 8.0 to 15; and

R′ (when a>0) represents C1 to C18 alkyl, preferably C3 to C15 alkyl, preferably C5 to C12 alkyl. The C₁ to C₁₈ alkyl R′ group can be linear or branched, substituted or unsubstituted. R′ may be selected from phenyl, alkyl phenyl, phenyl alkyl or a derivative thereof.

R″ is a disubstituted hydrocarbon moiety that has from 2.0 to 5.0 carbons, preferably from 2.0 to 4.0, more preferably 3.0 carbons, that is, R″ is more preferably a linear —CH₂—CH₂—CH₂-moiety.

a is the mol % of hydrophobic monomers, b is the mol % of substituted ammonium monomers, c the mol % of vinyl alcohol monomers and d is the mol % of vinyl acetal monomers. a+b+c+d add up to at least 90, preferably 98 and more preferably 100, excluding residues such as initiation molecules and the like. The hydrophobic monomer can be linear, branched or aromatic. The monomers may be present as blocks or randomly distributed, or a mix of blocks units and randomly distributed.

Where the cationic polyvinyl alcohol is desired to be hydrophilic, a is less than 0.5, more preferably less than 0.1, most preferably 0. For such hydrophilic cationic polyvinyl alcohols, b can be from 0.1 to 20, preferably from 0.5 to 15, more preferably from 1.0 to 10.0. Such hydrophilic cationic polyvinyl alcohols have been found to result in the wash or rinse solution having a less greasy and slippery feel, and hence avoiding giving the user the impression that the wash or rinse water is overly dirty.

Where the cationic polyvinyl alcohol is desired to be hydrophobic, a can be from 0.5 to 5.0, preferably from 1.0 to 4.0, more preferably from 2.0 to 3.0. For such hydrophobic cationic polyvinyl alcohols, b can be from 0.5 to 20, preferably from 2.0 to 10, more preferably from 4.0 to 6.0. Such hydrophobic cationic polyvinyl alcohols have been found to be particularly effective at improving drying times for treated hard surfaces.

The cationic ammonium group is bound to the polyvinyl alcohol polymer backbone via a linking alkyl chain to an acetal moiety, and f is the number of carbon atoms between the cationic group (e.g. the ammonium nitrogen) and the central carbon of the acetal moiety. As such, f is an average of from 2.0 to 5.0, preferably from 2.0 to 4.0, more preferably 3.0. It has been found that by synthesizing the polymer with the aforementioned values of f, the steric hindrance and charge repulsion which can limit the reaction of the cationic acetal with the polymer can be avoided.

Rx and Ry are independently selected from the group consisting of a C1 to C18 alkyl or aryl or alkylaryl, preferably C1 to C3, more preferably methyl. Rz is a H or a C1 to C18 alkyl or aryl or alkylaryl, preferably C1 to C3, more preferably methyl. The substituted ammonium group can be a “tertiary ammonium group”, where Rz is H, or “quaternary ammonium” group, where Rz is alkyl.

The cationic polyvinyl alcohol can be derived from a starting polyvinyl alcohol having virtually any molecular weight (weight average) or degree of polymerization (number average). Exemplary embodiments of the present invention include cationic polyvinyl alcohols derived from starting polyvinyl alcohols having weight average molecular weights of from about 10 to 300 kDa, preferably from 50 to 250 kDa, more preferably from 100 to 220 kDa,

The cationic polyvinyl alcohol may be characterized by a cationic charge density. Cationic charge density is typically expressed as milliequivalents of charge per gram of compound (meq/g). The hydrophilic cationic polyvinyl alcohols of the present disclosure may be characterized by a cationic charge density (or “CCD”) ranging from 0.05 to 5.0 meq/g, preferably from 0.1 to 2.5 meq/g, more preferably from 0.2 to 1.0 meq/g.

Methods of determining degree of polymerization (number average (DPn) and weight average (DPw)), degree of substitution, and cationic charge density are well known.

Cationic polyvinyl alcohol polymers according to formula (I) can be made by any means. The exemplary embodiments discussed herein were generally made by polymerizing vinyl acetate monomers to form a polyvinyl alcohol starting polymer. The polyvinyl alcohol starting polymer may be partially substituted with acetate groups. The acetate groups may be converted to hydroxyl groups by hydrolysis to obtain a deacetylized polyvinyl alcohol (PVA). This polyvinyl alcohol polymer can be subsequently post-modified through a condensation reaction with a cationic acetal, and optionally small amounts of a hydrophobic aldehyde, such as octanal or decanal, to obtain the cationic polyvinyl alcohol polymers discussed.

Within such a condensation reaction part of the hydroxyl groups of the polyvinyl alcohol polymer (specifically, adjacent hydroxyl groups) are converted into acetal groups. As such the cationic polyvinyl alcohol polymer comprises polyvinyl alcohol and cationic polyvinyl acetal subunits, with optionally small amounts of hydrophobic polyvinyl acetal sub-units. The remaining hydroxyl groups of the cationic polyvinyl alcohol polymer maybe 100% hydrolysed (i.e. d=0) or may be less than 100% hydrolyzed (i.e. d>0). The cationic polyvinyl alcohol polymer may be less than 100% hydrolyzed by starting with a partially hydrolyzed polyvinyl alcohol polymer (degree of hydrolysis of less than 100%), or by acetylating the 100% hydrolyzed cationic polyvinyl alcohol polymer.

These polyvinyl alcohol, cationic polyvinyl acetal, and optional polyvinyl acetate subunits and/or hydrophobic polyvinyl acetal sub-units can be organized in blocks or randomly.

### Examples

The benefits and advantageous of the novel cationically modified polyvinyl alcohol polymers may be seen in the following, non-limiting, examples.

### Liquid Hand Dishwashing Detergent Composition Comprising Cationically Modified Polyvinyl Alcohol Polymers

The liquid hand dishwashing detergent composition can comprise from 0.01% to 5%, preferably from 0.05% to 3%, more preferably from 0.1% to 2%, even more preferably from 0.25% to 1.0%, by weight of the detergent composition of the cationic polyvinyl alcohol of the present invention. The composition is a liquid cleaning composition, which is a liquid hand dishwashing composition, and hence is in liquid form. The liquid hand dishwashing composition is preferably an aqueous composition. As such, the composition can comprise from 50% to 85%, preferably from 50% to 75%, by weight of the total composition of water.

The liquid composition may have a pH greater than 6.0, or a pH of from 6.0 to 12.0, preferably from 7.0 to 11.0, more preferably from 7.5 to 10.0, measured as a 10% aqueous solution in demineralized water at 20° C.

The cationically modified polyvinyl alcohol polymers may modify the viscosity of the composition. Compositions comprising cationically modified polyvinyl alcohol polymers of the present invention can be Newtonian or non-Newtonian, preferably Newtonian, over the usage shear rate range which is typically from 0.1 s⁻¹ to 100 s⁻¹. Preferably, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof, over the typical usage shear rate range.

Compositions comprising the molecules of the present invention may further comprise an optional surfactant system. The liquid composition may comprise from 0.0% to 50%, preferably from 6.0% to 40%, most preferably from 15% to 35%, by weight of the total composition of a surfactant system. The surfactant system may comprise anionic surfactants. The surfactant system may comprise cosurfactants

### Anionic Surfactant

The surfactant system comprises an anionic surfactant. The surfactant system can comprise at least 40%, preferably from 50% to 80%, more preferably from 55% to 70% by weight of the surfactant system of the anionic surfactant. The surfactant system is preferably free of fatty acid or salt thereof, since such fatty acids impede the generation of suds.

Suitable anionic surfactants can be selected from the group consisting of: alkyl sulphate surfactant, alkyl alkoxy sulphate surfactant, alkyl sulphonate surfactant, alkyl sulphosuccinate and dialkyl sulphosuccinate ester surfactants, and mixtures thereof. The alkyl moiety may be straight-chain or branched.

The anionic surfactant can comprise at least 70%, preferably at least 85%, more preferably 100% by weight of the anionic surfactant of alkyl sulphate anionic surfactant, alkyl alkoxy sulphate anionic surfactant, or a mixture thereof.

The alkyl alkoxy sulphate surfactant can have an average degree of alkoxylation of less than 3.5, preferably from 0.3 to 2.0, more preferably from 0.5 to 0.9, in order to

Preferred alkyl alkoxy sulphates are alkyl ethoxy sulphates.

Suitable counterions include alkali metal cations, earth alkali metal cations, alkanolammonium or ammonium or substituted ammonium cations. The cation is preferably sodium.

Anionic alkyl sulphonate or sulphonic acid surfactants suitable for use herein include the acid and salt forms of alkylbenzene sulphonates, alkyl ester sulphonates, primary and secondary alkane sulphonates such as paraffin sulfonates, alpha or internal olefin sulphonates, alkyl sulphonated (poly)carboxylic acids, and mixtures thereof.

Alkyl sulfosuccinate and dialkyl sulfosuccinate esters are organic compounds with the formula MO3SCH(CO2R′)CH2CO2R where R and R′ can be H or alkyl groups, and M is a counter-ion such as sodium (Na). Alkyl sulfosuccinate and dialkyl sulfosuccinate ester surfactants can be alkoxylated or non-alkoxylated, preferably non-alkoxylated.

### Co-Surfactant

The surfactant system can comprise a co-surfactant. The co-surfactant can be selected from the group consisting of an amphoteric surfactant, a non-ionic surfactant, a zwitterionic surfactant and mixtures thereof.

The anionic surfactant to the co-surfactant weight ratio can be from 1:1 to 8:1, preferably from 2:1 to 5:1, more preferably from 2.5:1 to 4:1.

The co-surfactant is preferably an amphoteric surfactant, more preferably an amine oxide surfactant.

Suitable zwitterionic surfactants include betaine surfactants. Such betaine surfactants includes alkyl betaines, alkylamidobetaine, amidazoliniumbetaine, sulphobetaine (INCI Sultaines) as well as the phosphobetaine.

### Nonionic Surfactant

The surfactant system can further comprise a nonionic surfactant. Suitable nonionic surfactants include alkoxylated alcohol nonionic surfactants, alkyl polyglucoside nonionic surfactants, and mixtures thereof.

### Test Methods

### Water Sheeting:

The speed of drying is related to the degree of water-sheeting. The higher the water-sheeting, the less water retained on the wet article.

The water sheeting behavior is evaluated by washing grey ceramic plates (“Dinera” plates, 26 cm diameter, sourced from IKEA) with the hand dishwashing detergent test compositions, followed by scoring the amount of water sheeting observed on the plate when leaving them vertically on a drying rack. More particularly:

A sponge (Scotch-Brite® Classic-schuurspons van cellulose—supplied by 3M Belgium—dimension: 7 cm*10 cm) is homogeneously wetted with water of hardness 0.36 mmol/l CaCO₃ equivalence, at 25° C., by saturating the sponge with water, and subsequently manually squeezing until no further water is squeezed out).

1 ml of the hand dishwashing composition is homogeneously distributed over the sponge. The sponge is manually squeezed with full force 4 times above the ceramic plate using one hand to create foam, followed by washing the plate in 10 circular clockwise motions covering the edges as well as the center part of the plate, so that the full plate is treated with the foam.

The plate is then rinsed for 30 seconds under a running tap (25° C. water of having the same water hardness as before) at a sufficient flow rate to enable full foam removal and full coverage with water after which the plate is placed vertically on a drying rack under standard room conditions (20+/−1° C.).

The water running down the plate is then visually evaluated and a score of between 0-100% is given depending on the amount of water that has run down the plate in the first 30 sec, and therefore leaving an area of the plate already dry. 0% corresponds to water remaining on the full plate, 50% indicates that the half of the plate is covered with a film of water, and 100% indicating that no water film is visibly present.

### Foam Rinsing Test Method:

Conical centrifuge tubes (50 ml, supplied by Corning under the Falcon™ tradename) are mounted together in a placeholder rack to allow parallel measurements with matching exposure conditions.
1. 10 g of test solution for each leg, consisting of a 1.0 wt % solution of the respective detergent composition in water of targeted water hardness at room temperature (20° C.), is added into each tube.
2. All the tubes are simultaneously shaken 10 times in a vertical up and down direction at a speed of 2 strokes per second (1 stroke reflects a 25 cm vertical up and down motion), such that the liquid makes contact once with the screw cap during each stroke movement step, in order to generate the suds.
3. Within 30 s after shaking, the initial suds volume (in ml) is determined.
4. The liquid is then decanted such that only the suds remain.
5. The centrifuge tubes containing the suds are then gently filled via a calibrated bottle dispenser (such as a Dispensette® bottle dispenser from Sigma Aldrich) via the tube wall with 10 mL water rinse solution of targeted water hardness at 20° C.
6. All the tubes are again simultaneously shaken.
7. Within 30 s after shaking, the suds volume is re-measured and the liquid is decanted again. In this way, steps 5 through 7 represent a rinse cycle.
8. The rinse cycle is repeated until the suds volume reaches 0 ml.
9. The following data are obtained by Boltzmann fitting and the average of 3 replicates is reported: Starting suds volume—V50 (amount of cycles to reach half of the starting suds volume). A Boltzmann fitting of the curve is done by nonlinear regression: Start/(1+exp(−(v50−cycle)/slope)).

### EXAMPLES

### Synthesis Examples

Cationic polyvinyl alcohols of the present invention were synthesized as outlined below. TABLE 1 includes a number of exemplary embodiments of the present invention.

TABLE 1
Polyvinyl alcohols of use in inventive and comparative compositions:

| | Cationic Polyvinyl alcohol | | | | | | | | | | | |
|---|---|---|---|---|---|---|---|---|---|---|---|---|
| | | | | | | | | | | | CCD | Mw¹ |
| | a | b | c | d | R′ | R″ | Rx | Ry | Rz | X | (mEq/g) | (kDa) |
| 1 | 2.7 | 4.7 | 81.7 | 10.8 | C9 | 3 | CH₃ | CH₃ | CH₃ | Cl | 0.8 | 130 |
| 2 | 2.6 | 4.7 | 81.5 | 11.2 | C6 | 3 | CH₃ | CH₃ | CH₃ | Cl | 0.8 | 130 |
| 3 | 0 | 5.1 | 83.5 | 11.4 | — | 3 | CH₃ | CH₃ | CH₃ | Cl | 0.9 | 130 |

| | | | | | | | | | | | | |
|---|---|---|---|---|---|---|---|---|---|---|---|---|
| 4 | 0 | 2.3 | 79.4 | 18.3 | — | 3 | CH₃ | CH₃ | CH₃ | Cl | 0.4 | 9-10 |
| 5 | 0 | 4.8 | 76.4 | 18.8 | — | 3 | CH₃ | CH₃ | CH₃ | Cl | 0.8 | 9-10 |
| 6 | 0 | 1.5 | 91.2 | 7.4 | — | 3 | CH₃ | CH₃ | CH₃ | Cl | 0.3 | 31 |
| 7 | 0 | 4.4 | 90.2 | 5.3 | — | 3 | CH₃ | CH₃ | CH₃ | Cl | 0.8 | 31 |
| 8 | 0 | 1.4 | 93.1 | 5.4 | — | 3 | CH₃ | CH₃ | CH₃ | Cl | 0.3 | 67 |
| 9 | 0 | 4.5 | 90.7 | 4.8 | — | 3 | CH₃ | CH₃ | CH₃ | Cl | 0.8 | 67 |
| 10 | 0 | 8.5 | 79.0 | 12.5 | — | 3 | CH₃ | CH₃ | CH₃ | Cl | 1.3 | 67 |
| 11 | 0 | 2.6 | 85.8 | 11.6 | — | 3 | CH₃ | CH₃ | CH₃ | Cl | 0.5 | 130 |
| 12 | 0 | 7.3 | 80.8 | 11.9 | — | 3 | CH₃ | CH₃ | CH₃ | Cl | 1.2 | 130 |
| 13 | 0 | 9.8 | 78.6 | 11.6 | — | 3 | CH₃ | CH₃ | CH₃ | Cl | 1.4 | 130 |
| 14 | 0 | 4.6 | 82.7 | 12.7 | — | 3 | CH₃ | CH₃ | CH₃ | Cl | 0.8 | 205 |
| 15 | 0 | 9.8 | 76.2 | 14.0 | — | 3 | CH₃ | CH₃ | CH₃ | Cl | 1.4 | 205 |
| 16 | 2.7 | 6.9 | 79.9 | 10.5 | C6 | 3 | CH₃ | CH₃ | CH₃ | Cl | 1.1 | 130 |
| 17 | 3.1 | 7.3 | 78.1 | 11.5 | C9 | 3 | CH₃ | CH₃ | CH₃ | Cl | 1.1 | 130 |

¹of the starting polyvinyl alcohol as listed on the certificate of analysis

### Quaternization of 4-(dimethylamino)butyraldehyde Diethyl Acetal (Cationic Acetal)

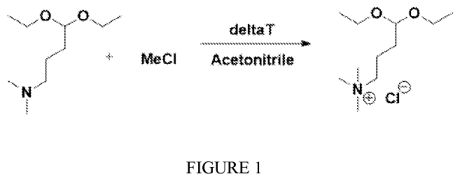

4-(dimethylamino)butyraldehyde diethyl acetal was quaternized using the following procedure (see FIG. 1):

29 mL of 4-(dimethylamino)butyraldehyde diethyl acetal and 60 mL of acetonitrile were added to a 160 mL Parr reactor. The reactor was purged three times with 50 psi nitrogen. 8.6 g of chloromethane gas were added and the reactor heated to 60° C. and stirred for 23 h. Afterwards, the heat was turned off and once the mixture was cooled to room temperature, it was purged with nitrogen. The material was precipitated into diethyl ether at a temperature of −18° C. and most of the diethyl ether was decanted off. The precipitate was washed with ice cold diethyl ether and residual diethyl ether was removed using a rotary evaporator, which yielded a viscous, yellow oil at room temperature. Traces of unreacted amine or aldehyde due to hydrolysis of the acetal might be present and can be removed by means known to the skilled person.

The chemical structure of the cationic acetal was confirmed by ¹H NMR spectroscopy. The spectra were recorded at 25±0.2° C. using a Bruker AVANCE III 300 MHz Spectrometer, equipped with a broad band observe probe with Z-gradient. 10 mg of cationic acetal was dissolved in 0.7-0.8 mL of D₂O.

### Synthesis of Hydrophobically Modified Cationic Polyvinyl Alcohol 1 and 17:

A 10 wt % aqueous solution of polyvinyl alcohol (Mowiol 18-88, sourced from Sigma Aldrich, viscosity of 17.5 mPas as a 4% aqueous solution in DI water at 20° C.) was prepared by placing 90 g of demineralized water into a beaker, covering it with foil, heating the water to 90° C. and adding 10 g of the polyvinyl alcohol incrementally while stirring. Once the polymer was fully dissolved and a homogeneous solution was obtained, the heat was turned off and the solution was allowed to cool down to room temperature. To this solution, 0.9 mL of 12 M hydrochloric acid solution was added. 2.44 g of the cationic acetal prepared earlier was weighed into a vial and dissolved in 10 mL of DI water. This solution was added to the beaker and residual material was washed into the beaker using 2 mL of DI water. Afterwards, 0.8 mL decanal was added to the beaker and the beaker was closed with a lid. The mixture was stirred at room temperature for 24 hours. During this time, additional DI water was added to ensure proper stirring and avoiding the material gelling. The reaction mixture was brought back to a pH in the range 6-7 using 13.5 mL of an aqueous sodium hydroxide solution (1 M). The resulting reaction mixture was poured into a freeze dryer tray, diluted with 1 L of additional demineralized water and placed into the freezer. Once the mixture was frozen, it was placed into the freeze dryer. Freeze drying yielded a white polymer containing residual salts and traces of unreacted cationic acetal, aldehyde, or intermolecular reaction by-products. The material was dissolved in DI water and dialyzed against DI water (dialysis tube pore size 3.5 kDa MWCO) to remove small molecule impurities. The solution was freeze-dried to yield the purified polymer. Examples 1 and 17 were prepared using this procedure, utilizing the listed polyvinyl alcohol and adjusting the respective amount of cationic acetal and sodium hydroxide solution if needed.

### Synthesis of Hydrophobically Modified Cationic Polyvinyl Alcohol 2 and 16:

A 10 wt % aqueous solution of polyvinyl alcohol (Mowiol 18-88, sourced from Sigma Aldrich, viscosity of 17.5 mPas as a 4% aqueous solution in DI water at 20° C.) was prepared by placing 90 g of demineralized water into a beaker, covering it with foil, heating the water to 90° C. and adding 10 g of the polyvinyl alcohol incrementally while stirring. Once the polymer was fully dissolved and a homogeneous solution was obtained, the heat was turned off and the solution was allowed to cool down to room temperature. To this solution, 0.9 mL of 12 M hydrochloric acid solution was added. 2.44 g of cationic acetal was weighed into a vial and dissolved in 10 mL of DI water. This solution was added to the beaker and residual material was washed into the beaker using 2 mL of DI water. Afterwards, 0.6 mL heptanal was added to the beaker and the beaker was closed with a lid. The mixture was stirred at room temperature for 24 hours. The reaction mixture was brought back to a pH 6-7 using 13 mL of an aqueous sodium hydroxide solution (1 M). The resulting reaction mixture was poured into a freeze dryer tray, diluted with 1 L of additional demineralized water and placed into the freezer. Freeze drying yielded a white polymer containing residual salts which might further contain traces of unreacted acetal, aldehyde, and its respective oxidation product or intermolecular reaction by-products. Examples 2 and 16 were prepared using this procedure, utilizing the listed polyvinyl alcohol and adjusting the respective amount of cationic acetal and sodium hydroxide solution if needed.

### Synthesis of Cationic Polyvinyl Alcohol 3, 4, 5, 10-15:

A 10 wt % aqueous solution of polyvinyl alcohol (Mowiol 18-88, sourced from Sigma Aldrich, viscosity of 17.5 mPas as a 4% aqueous solution in DI water at 20° C.) was prepared by placing 225 g of demineralized water into a beaker, covering it with foil, heating the water to 90° C. and adding 25 g of the polyvinyl alcohol incrementally while stirring. Once the polymer was fully dissolved and a homogeneous solution was obtained, the heat was turned off and the solution was allowed to cool down to room temperature. To this cooled down solution, 2.1 mL of 12 M hydrochloric acid solution was added. 6.11 g of the cationic acetal (amount depending on targeted degree of acetalization) was weighed into a vial, dissolved in 10 mL of DI water and added to the beaker. Additional 2 mL of DI water was used to wash any residual acetal material into the beaker and the beaker was closed with a lid. The mixture was stirred at room temperature for 12 to 24 hours. The reaction mixture was brought back to a pH of 6-7 using 32 mL of aqueous sodium hydroxide solution (1 M). The resulting reaction mixture was poured into a freeze dryer tray, diluted with 1 L of additional demineralized water and placed into the freeze dryer. Freeze drying yielded a white polymer containing residual salts which might further contain traces of unreacted cationic acetal, unreacted cationic acetal that hydrolyzed to the aldehyde and its respective oxidation product or intermolecular reaction by-products. Examples 3, 4, 5, 10-15 were prepared using this procedure, utilizing the listed polyvinyl alcohol and adjusting the respective amount of cationic acetal and sodium hydroxide solution if needed.

### Synthesis of Cationic Polyvinyl Alcohol 6-9:

A 3-neck round bottom flask, equipped with a reflux condenser, a stir bar and septa was filled with 215 mL DI water and the solution was heated to 90° C. under stirring. 25 g of polyvinyl alcohol (Mowiol 4-88, sourced from Sigma Aldrich, viscosity of 3.8 mPas as a 4% aqueous solution in DI water at 20° C.) were added portion wise under stirring. Once the polymer was fully dissolved and a homogeneous solution was obtained, the heat was lowered to 80° C. 2.1 mL of 12 M hydrochloric acid was dissolved in 5 mL DI water and carefully added to this solution. 2.05 g of cationic acetal was weighed into a vial, dissolved in 10 mL DI water, and added to the hot, acidified polyvinyl alcohol solution. An additional 2 mL of DI water was used to wash any residual acetal material into the flask. The solution was stirred for 1.5 h at 80° C. and after that the heating was turned off and the solution was continued to stir for 12 to 24 hours. The reaction mixture was brought back to a pH of 6-7 using 46 mL of aqueous sodium hydroxide solution (1 M). The resulting reaction mixture was poured into a freeze dryer tray, diluted with 1 L of additional demineralized water and placed into a freeze dryer. Freeze drying yielded a white polymer containing residual salts which might further contain traces of unreacted cationic acetal, unreacted cationic acetal that hydrolyzed to the aldehyde and its respective oxidation product or intermolecular reaction by-products. Examples 6-9 were prepared using this procedure, utilizing the listed polyvinyl alcohol and adjusting the respective amount of cationic acetal and sodium hydroxide solution if needed.

### Comparative Tests:

To demonstrate the properties of the inventive cationic polyvinyl alcohols the following compositions were formulated by simple mixing. Example 1 comprised cationic polyvinyl alcohol 1, while Example 2 comprised cationic polyvinyl alcohol 2, and Example 3 comprised cationic polyvinyl alcohol 3. Both cationic polyvinyl alcohol 1 and 2 were hydrophobically modified, while example 3 comprised cationic polyvinyl alcohol 3 which was hydrophilic. Example A comprised an alternative commercial cationic polyvinyl alcohol (Poval® 23-88CM), Example B comprised a non-cationic hydrolysed polyvinyl alcohol and the composition of example C comprised a cationic polysaccharide (Supracare® 212).

TABLE 2
Comparative and inventive liquid detergent compositions:

| | wt % (100% active basis) | | | | | |
|---|---|---|---|---|---|---|
| | Ex 1 | Ex 2 | Ex 3 | Ex A* | Ex B* | Ex C* |
| C12-13 alkyl EO0.6 sulfate | 9.5 | 9.5 | 9.5 | 9.5 | 9.5 | 9.5 |
| (42.03% branching) | | | | | | |
| C12-14 dimethyl amine oxide | 4.7 | 4.7 | 4.7 | 4.7 | 4.7 | 4.7 |
| C9-11 EO8 nonionic surfactant³ | 7.1 | 7.1 | 7.1 | 7.1 | 7.1 | 7.1 |
| C12-14 alkyl polyglucoside⁴ | 7.1 | 7.1 | 7.1 | 7.1 | 7.1 | 7.1 |
| EO-PO-EO copolymer⁵ | 0.5 | 0.5 | 0.5 | 0.5 | 0.5 | 0.5 |
| 2-methyldiaminocyclohexane⁶ | 0.22 | 0.22 | 0.22 | 0.22 | 0.22 | 0.22 |
| Sodium citrate | 1.0 | 1.0 | 1.0 | 1.0 | 1.0 | 1.0 |
| MgCl₂ | 0.2 | 0.2 | 0.2 | 0.2 | 0.2 | 0.2 |
| PPG (MW2000) | 0.4 | 0.4 | 0.4 | 0.4 | 0.4 | 0.4 |
| Sodium cumene sulfonate | 2.25 | 2.25 | 2.25 | 2.25 | 2.25 | 2.25 |
| Ethanol | 3.1 | 3.1 | 3.1 | 3.1 | 3.1 | 3.1 |
| Cationic polyvinyl alcohol 1 | 0.5 | 0 | 0 | 0 | 0 | 0 |
| Cationic polyvinyl alcohol 2 | 0 | 0.5 | 0 | 0 | 0 | 0 |
| Cationic polyvinyl alcohol 3 | 0 | 0 | 0.5 | 0 | 0 | 0 |
| Cationic polyvinyl alcohol A⁷ | 0 | 0 | 0 | 0.5 | 0 | 0 |
| Hydrolysed polyvinyl alcohol⁸ | 0 | 0 | 0 | 0 | 0.5 | 0 |
| Cationic cellulose⁹ | 0 | 0 | 0 | 0 | 0 | 0.5 |
| Water and minors (perfume, | bal. | bal. | bal. | bal. | bal. | bal. |
| dye, preservatives . . . ) | | | | | | |
| pH (10% solution in demi water) | 7.5 | 7.5 | 7.5 | 7.5 | 7.5 | 7.5 |

*Comparative
³sold under the tradename of Neodol ®, supplied by Shell
⁴sold under the tradename of Glucopon 600 CSUP by BASF
⁵Ethylene oxide/propylene oxide block copolymer sold under the tradename Tergitol ® L64E by Dow
⁶sold under the tradename Baxxodur ® EC210 by BASF
⁷Available as Poval ® 23-88CM from Kuraray
⁸Available as Mowiol 18-88 from Sigma Aldrich
⁹Polymeric quaternary ammonium salt of hydroxyethyl cellulose, sold under the tradename Supracare ® 212 by DOW, cationic charge density (CCD) of from 1.1 to 1.6 mEq/g

### Comparison of Drying Benefit:

The drying benefit from inventive example 1, and comparative examples A, B and C were evaluated by measuring the water-sheeting results after rinsing, using the procedures described herein. The results are given below:

TABLE 3
Results of water sheeting test:

| wt % (100% active basis) | Ex 1 | Ex A* | Ex B* | Ex C* |
|---|---|---|---|---|
| Cationic polyvinyl alcohol 1 | 0.5 | 0 | 0 | 0 |
| Cationic polyvinyl alcohol A ⁷ | 0 | 0.5 | 0 | 0 |
| Hydrolysed polyvinyl alcohol⁸ | 0 | 0 | 0.5 | 0 |
| Cationic cellulose⁹ | 0 | 0 | 0 | 0.5 |
| Water sheeting % | 95 | 75 | 5 | 50 |

⁷ Available as Poval ® 23-88CM from Kuraray
⁸Available as Mowiol 18-88 from Sigma Aldrich

As can be seen from the results of comparative example C of TABLE 3, unmodified hydrolysed polyvinyl alcohols provide negligible drying benefit, as seen from the water-sheeting results. As expected from the prior art, cationic cellulose provides a noticeable improvement in drying benefit. The drying benefit is further improved when the cationic cellulose is replaced by a non-hydrophobically modified cationic polyvinyl alcohol (Cationic polyvinyl alcohol A, used in the composition of comparative example A). However, as can be seen from the water-sheeting results from example 1, an even greater improvement in drying is achieved when a hydrophobically modified polyvinyl alcohol of the present invention is used.

The following compositions comprising a betaine as co-surfactant were made by simple mixing and the rinsing benefit also assessed.

From the results of TABLE 4, it can be seen that the cationic polyvinyl alcohols of the present invention also improve rinsing when incorporated into compositions comprising alkyl ether sulfate anionic surfactant and betaine co-surfactant.

From the results of TABLE 5, it can be seen that the cationic polyvinyl alcohol of the present invention also improves rinsing when incorporated into compositions comprising alkyl sulfate (i.e. unethoxylated) anionic surfactant and betaine co-surfactant.

TABLE 4
Rinsing benefit from comparative and inventive liquid hand
dishwashing detergent compositions comprising alkyl ethoxylated
sulfate anionic surfactant and betaine co-surfactant:

| wt % (100% active basis) | Ex 3 | Ex 5 | Ex 6 | Ex D* | Ex E* |
|---|---|---|---|---|---|
| C12-13 alkyl EO0.6 sulfate | 19.6 | 19.6 | 19.6 | 19.6 | 19.6 |
| (34.7% branching) | | | | | |
| C12-14 amidopropyl betaine¹⁰ | 6.5 | 6.5 | 6.5 | 6.5 | 6.5 |
| C9-11 EO8 nonionic surfactant | 1.0 | 1.0 | 1.0 | 1.0 | 1.0 |
| NaCl | 0.7 | 0.7 | 0.7 | 0.7 | 0.7 |
| PPG (MW2000) | 0.7 | 0.7 | 0.7 | 0.7 | 0.7 |
| Ethanol | 1.8 | 1.8 | 1.8 | 1.8 | 1.8 |
| Cationic polyvinyl alcohol 1 | 0.5 | 0 | 0 | 0 | 0 |
| Cationic polyvinyl alcohol 2 | 0 | 0.5 | 0 | 0 | 0 |
| Cationic polyvinyl alcohol 3 | 0 | 0 | 0.5 | 0 | 0 |
| Cationic polyvinyl alcohol A ⁷ | 0 | 0 | 0 | 0.5 | 0 |
| Hydrolysed polyvinyl alcohol⁸ | 0 | 0 | 0 | 0 | 0.5 |
| Water and minors (perfume, | bal. | bal. | bal. | bal. | bal. |
| dye, preservatives . . .) | | | | | |
| pH (10% solution in demi water) | 9.0 | 9.0 | 9.0 | 9.0 | 9.0 |
| Initial suds volume (ml) | 29.16 | 29.65 | 30.87 | 30.61 | 31.36 |
| Av. number of rinse cycles | 2.97 | 2.96 | 3.05 | 3.24 | 3.36 |
| to reach V50 | | | | | |

¹⁰sold under the tradename Dehyton ® KE UP by BASF

TABLE 5
Rinsing benefit from comparative and inventive liquid hand
dishwashing detergent compositions comprising alkyl sulfate
anionic surfactant and betaine co-surfactant:

| wt % (100% active basis) | Ex 7 | Ex F* | Ex G* | Ex H* |
|---|---|---|---|---|
| C12-13 alkyl sulfate | 19.81 | 19.81 | 19.81 | 19.81 |
| (30.4% branching) | | | | |
| C12-14 amidopropyl betaine¹⁰ | 6.6 | 6.6 | 6.6 | 6.6 |
| C9-11 EO8 nonionic surfactant¹ | 2.0 | 2.0 | 2.0 | 2.0 |
| NaCl | 0.7 | 0.7 | 0.7 | 0.7 |
| PPG (MW2000) | 0.9 | 0.9 | 0.9 | 0.9 |
| Ethanol | 3.1 | 3.1 | 3.1 | 3.1 |
| Cationic polyvinyl alcohol 1 | 0.5 | 0 | 0 | 0 |
| Cationic polyvinyl alcohol 2 | 0 | 0 | 0 | 0 |
| Cationic polyvinyl alcohol 3 | 0 | 0.5 | 0 | 0 |
| Cationic polyvinyl alcohol A ⁷ | 0 | 0 | 0.5 | 0 |
| Hydrolysed polyvinyl alcohol⁸ | 0 | 0 | 0 | 0.5 |
| Water and minors (perfume, | bal. | bal. | bal. | bal. |
| dye, preservatives . . .) | | | | |
| pH (10% solution in demi water) | 9.0 | 9.0 | 9.0 | 9.0 |
| Initial suds volume (ml) | 26.67 | 31.27 | 30.71 | 30.03 |
| Av. number of rinse cycles | 3.04 | 3.3 | 3.44 | 3.65 |
| to reach V50 | | | | |

³ sold under the tradename of Neodol ®, supplied by Shell
⁴ sold under the tradename of Glucopon 600 CSUP by BASF
⁵ Ethylene oxide/propylene oxide block copolymer sold under the tradename Tergitol ® L64E by Dow
⁶ sold under the tradename Baxxodur ® EC210 by BASF
⁷ Available as Poval ® 23-88CM from Kuraray
⁸Available as Mowiol 18-88 from Sigma Aldrich
⁹ Polymeric quaternary ammonium salt of hydroxyethyl cellulose, sold under the tradename Supracare ® 212 by DOW, cationic charge density (CCD) of from 1.1 to 1.6 mEq/g
¹⁰sold under the tradename Dehyton ® KE UP by BASF

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Values disclosed herein as ends of ranges are not to be understood as being strictly limited to the exact numerical values recited. Instead, unless otherwise specified, each numerical range is intended to mean both the recited values and any real numbers including integers within the range. For example, a range disclosed as “1 to 10” is intended to mean “1, 2, 3, 4, 5, 6, 7, 8, 9, and 10” and a range disclosed as “1 to 2” is intended to mean “1.1, 1.2, 1.3, 1.4, 1.5, 1.6, 1.7, 1.8, 1.9, and 2.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cationic polyvinyl alcohol, wherein the cationic polyvinyl alcohol has the formula (I): 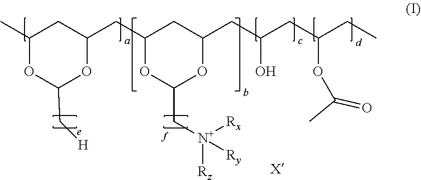
wherein:
a is from 0 to 5.0;
b is from 0.1 to 20;
c is from 40 to 98;
d is from 1.0 to 25;
wherein a, b, c, and d are mol % of the monomers present, such that a+b+c+d add up to at least 90;
e is an average of from 3.0 to 18;
f is an average of from 2.0 to 5.0;
Rx is a C1 to C3 alkyl;
Ry is a C1 to C3 alkyl; and
Rz is a H or C1 to C3 alkyl.

2. The cationic polyvinyl alcohol according to claim 1, wherein in the cationic polyvinyl alcohol:
a. c is from 65 to 95; and
b. d is from 3.0 to 20.

3. The cationic polyvinyl alcohol according to claim 2, wherein in the cationic polyvinyl alcohol:
a. c is from 75 to 85; and
b. d is from 8.0 to 15.

4. The cationic polyvinyl alcohol according to claim 1, wherein the cationically polyvinyl alcohol is hydrophilic, wherein:
a. a is less than 0.5; and
b. b is from 0.1 to 20.

5. The cationic polyvinyl alcohol according to claim 4, wherein:
a. a is 0; and
b. b is from 1.0 to 10.0.

6. The cationic polyvinyl alcohol according to claim 1, wherein the cationically modified polyvinyl alcohol is hydrophobically modified, wherein:
a. a is from 0.5 to 5.0; and
b. b is from 0.5 to 20.

7. The cationic polyvinyl alcohol according to claim 6, wherein:
a. a is from 2.0 to 3.0; and
b. b is from 4.0 to 6.0.

8. The cationic polyvinyl alcohol according to claim 1, wherein the cationically polyvinyl alcohol is characterized by a weight average molecular weight of the starting polyvinyl alcohol of from 10 to 300 kDa.

9. The cationic polyvinyl alcohol according to claim 1, wherein Rx is a C1.

10. The cationic polyvinyl alcohol according to claim 1, wherein Rx is a methyl.

11. The cationic polyvinyl alcohol according to claim 1, wherein Ry is a C1.

12. The cationic polyvinyl alcohol according to claim 1, wherein Ry is a methyl.

13. The cationic polyvinyl alcohol according to claim 1, wherein Rz is a C1.

14. The cationic polyvinyl alcohol according to claim 1, wherein Rz is a methyl.

15. The cationic polyvinyl alcohol according to claim 1, wherein e is an average of from 5.0 to 12.

16. The cationic polyvinyl alcohol according to claim 1, wherein f is an average of from 2.0 to 4.0.

17. The cationic polyvinyl alcohol according to claim 6, wherein a is from 2.0 to 3.0.

18. The cationic polyvinyl alcohol according to claim 6, wherein b is from 4.0 to 6.0.

19. The cationic polyvinyl alcohol according to claim 8, wherein the weight average molecular weight of the starting polyvinyl alcohol is from 100 to 220 kDa.
